(19) United States
(12) Patent Application Publication
(10) Pub. No.: US 2009/0164342 A1
(43) Pub. Date: Jun. 25, 2009

(54) Making an Availability Determination Regarding a Requested Ware

(75) Inventor: Fabrice Laur, Heidelberg (DE)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 11/961,514

(22) Filed: Dec. 20, 2007

(51) Int. Cl. G06Q 10/00

(52) U.S. Cl. 705/28

(57) ABSTRACT

Among other disclosed subject matter, a computer-implemented method for making an availability determination regarding a requested ware includes identifying a request to provide a quantity of a ware at a delivery date. The method includes determining, in response to the identification, which one of multiple time periods includes the delivery date. The multiple time periods are at least three and run serially from a beginning time. Each of the multiple time periods corresponds to a step in a process to provide the ware and is associated with a different supply scope for determining ware availability. The method includes determining availability of the ware for the request using the supply scope of the determined time period.

### TECHNICAL FIELD

This document relates to making an availability determination regarding a requested ware.

### BACKGROUND

Organizations use computer-based systems to control some aspects of supplying wares. For example, a supply chain management system can be used to plan and/or execute the manufacture or procurement of goods that are to be sold to customers. Such systems can allow certain aspects of the process to be scheduled and specified, such as the amount of goods needed, when the delivery should take place, what machinery or other resources are to be used, to name a few examples.

Some systems have separate planning components. For example, some products from SAP AG include a Materials Requirement Planning component that can be used to plan the requirements for one or more materials, such as a raw material or a product. The output of a planning component can be based on forecasts of what future demands will be, and the plan can then be used to organize, analyze and/or execute operations in the organizations. For example, a plan can be laid out ahead in time, and more specific requirements such as sales orders can be added to the plan to replace parts thereof as they become available.

### SUMMARY

The invention relates to making an availability determination regarding a requested ware.

In a first aspect, a computer-implemented method for making an availability determination regarding a requested ware includes identifying a request to provide a quantity of a ware at a delivery date. The method includes determining, in response to the identification, which one of multiple time periods includes the delivery date. The multiple time periods are at least three and run serially from a beginning time. Each of the multiple time periods corresponds to a step in a process to provide the ware and is associated with a different supply scope for determining ware availability. The method includes determining availability of the ware for the request using the supply scope of the determined time period.

Implementations can include any, all or none of the following features. A lead time period of the multiple time periods furthest from the beginning time can be defined as beginning with a lead time horizon that represents a time required for a process of providing the ware. The supply scope for the lead time period can be defined such that when the delivery date falls beyond the lead time period the ware is always deemed to be available. The determination can include that the quantity of the ware is not available at the delivery date, and the method can further include determining availability of the ware for the request using the supply scope of the next time period; and if there is availability, generating a confirmation date within the next time period. The supply scope for a first one of the multiple time periods can include that the ware availability is determined against stock wares and ordered wares. The first time period can be defined as beginning at the beginning time and ending at a start execution horizon. The start execution horizon can be defined based on a conversion from a production request to a production order in the process to provide the ware. The supply scope for a second one of the multiple time periods can include that the ware availability is determined against stock wares, ordered wares and wares requested to be ordered. The second time period can be defined as beginning at the start execution horizon and ending at a release to production and purchasing horizon. The release to production and purchasing horizon can be defined based on a handover from planning in the process to provide the ware. The supply scope for a third one of the multiple time periods can include that the ware availability is determined against stock wares, ordered wares, wares requested to be ordered and planned wares. The supply scope for the first time period can include at least one selected from the group consisting of: a supply scope that the ware availability is determined against stock wares and wares ordered to be produced; a supply scope that the ware availability is determined against stock wares and wares ordered to be purchased; and combinations thereof. The method can further include later updating the determination when the delivery date is in another one of the multiple time periods, the updated determination being made using the supply scope of the other one of the multiple time periods.

In a second aspect, a computer program product is tangibly embodied in a computer-readable storage medium and includes instructions that when executed by a processor perform a method for making an availability determination regarding a requested ware. The method includes identifying a request to provide a quantity of a ware at a delivery date. The method includes determining, in response to the identification, which one of multiple time periods includes the delivery date. The multiple time periods are at least three and run serially from a beginning time. Each of the multiple time periods corresponds to a step in a process to provide the ware and is associated with a different supply scope for determining ware availability. The method includes determining availability of the ware for the request using the supply scope of the determined time period.

In a third aspect, a computer program product is tangibly embodied in a computer-readable storage medium, the computer program product including instructions that, when executed, generate on a display device a graphical user interface for defining multiple time periods for determining availability of a requested ware. The graphical user interface includes at least one input control for user entry of first and second horizons defining at least three time periods running serially from a beginning time. Each of the at least three time periods corresponds to a step in a process to provide a ware and is associated with a different supply scope for determining ware availability. When a request to provide a quantity of the ware at a delivery date is identified, it is determined which one of the at least three time periods includes the delivery date, and an availability of the ware for the request is determined using the supply scope of the determined time period.

Implementations can include any, all or none of the following features. A lead time period of the at least three time periods furthest from the beginning time can be defined as beginning with a lead time horizon that represents a time required for a process of providing the ware. The supply scope for a first one of the multiple time periods can include that the ware availability is determined against stock wares and ordered wares. The supply scope for the first time period can include at least one selected from the group consisting of: a supply scope that the ware availability is determined against stock wares and wares ordered to be produced; a supply scope that the ware availability is determined against stock wares and wares ordered to be purchased; and combinations thereof. The supply scope for a second one of the multiple time periods can include that the ware availability is determined against stock wares, ordered wares and requested wares. The supply scope for a third one of the multiple time periods can include that the ware availability is determined against stock wares, ordered wares, requested wares and planned wares.

Implementations can provide any, all or none of the following advantages. A more effective availability check can be provided. Availability can be determined in any of several time periods, with a scope of check depending on the period in which wares are requested. An availability confirmation can be repeatedly issued, each time based on increasingly reliable or certain supply information. Solutions can be provided that avoid or reduce failures to confirm product availability.

The details of one or more embodiments are set forth in the accompanying drawings and the description below. Other features and advantages will be apparent from the description and drawings, and from the claims.

### DESCRIPTION OF DRAWINGS

FIG. 1 is a chart that conceptually illustrates how an availability determination regarding requested wares can be made.

FIG. 2 shows two charts conceptually illustrating how the passage of time can affect the availability determination.

FIG. 3 is an example of a method that can be performed.

FIG. 4 is an example of a graphical user interface for determining horizons in an availability check.

FIG. 5 is a schematic diagram of a generic computer system. Like reference symbols in the various drawings indicate like elements.

### DETAILED DESCRIPTION

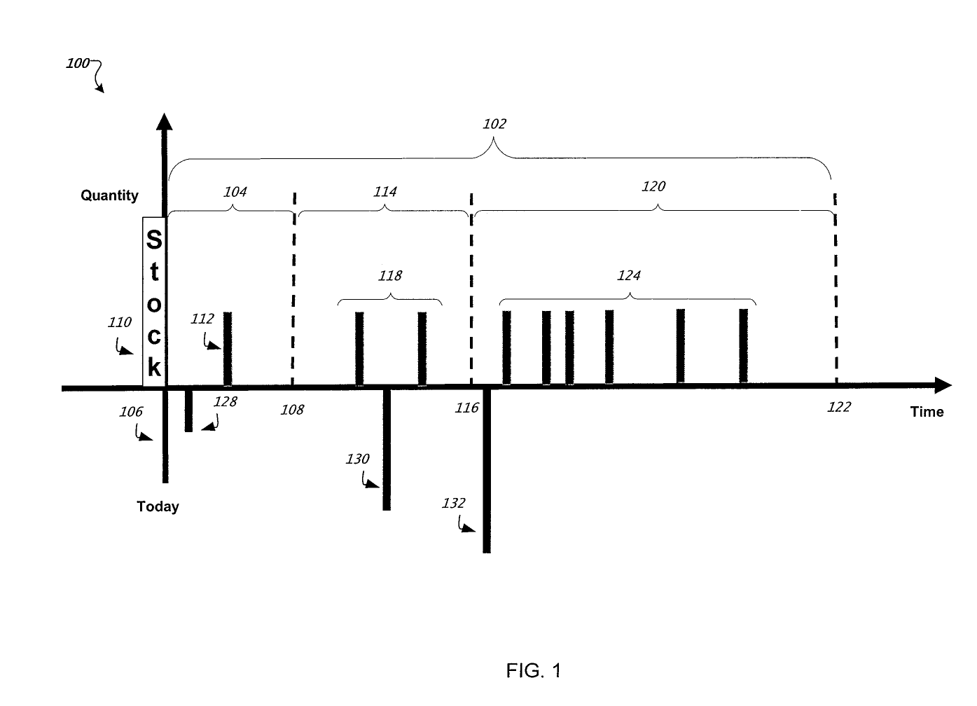

FIG. 1 is a chart 100 that conceptually illustrates how an availability determination regarding requested wares can be made. For example, suppliers can use a system that makes an availability determination whether a request from a customer can be filled by a particular delivery date, the determination made using other requests and also current and future supply information. To provide more precise data regarding the manufacturer's ability to fill the request, the availability determination can be performed in any or all of multiple time periods in the supply process. Each time period can relate to a particular stage in supplying a ware. The availability determination can match the delivery date to a corresponding time period and check the availability based on a scope of availability check associated with the time period.

The above and other examples herein refer to products being supplied and/or demanded. Other wares than products can be considered as well. In some implementations, wares such as services can be supplied and/or demanded. For example, services can be organized using a computer system that schedules availability of consultants or other professionals. Thus, a ware can be either a product or a service, or both, to name some examples. Also, while in some examples it is described that wares of one type are being demanded and supplied, in other implementations more than one type of ware can be supplied, for example by a company having a manufacturing plant that makes many different products.

For example, a manufacturer of watches may receive a request from a retail store for 50 watches to be delivered in 12 days. This manufacturer may have organized its operations such that the manufacturing process is first planned, thereafter a certain number of products are requested to be ordered based on the planning, and finally a production order to actually make the products is entered into the system based on the request. Several different scenarios are possible in that regard. The delivery date can fall within the time period it takes the manufacturer to order a watch to be produced. The availability determination can then use information specific to this time period to determine if the request can be granted. However, the availability determination can use different information if the delivery date falls within the time period to request to order the watch parts, the man-hours, and the machinery to put the watch parts together. The availability determination can use still other information if the delivery date falls within the time period to plan received requests. As another example, if the delivery date falls outside the length of time needed to plan, request to order, and order the watches, there may by default be sufficient time to meet the order regardless of the current volume of stock and/or pending requests. In some such examples, the availability determination can therefore automatically grant the request.

The user can determine the length of time needed for the supplier to plan, request to order, order, and stock an item, to name a few examples. This length of time can also be termed a lead time period 102. A request that originates beyond the horizon that ends this period can then be considered as moving through planning, requesting to order, ordering, and stocking stages as time continues. In the following example the request will be described as it appears in each of the periods for clarity.

The availability determination can use several time periods, including the lead time period. In some implementations, three or more time periods are used. A first time period 104 can be defined as beginning at a beginning time 106 and ending at a start execution horizon 108. For example, the beginning time 106 can represent a current day when the chart 100 is viewed (e.g., “Today” in FIG. 1). The start execution horizon 108 can represent the number of days from the beginning time 106 when an order must be generated to make or procure the product by the beginning time 106. This length of time can reflect how long a ware takes to be produced or purchased (e.g., 5 days). If a request is received within this first time period 104, or when the delivery date of a request received earlier falls within this period, the availability determination can check against a first supply scope for the first time period 104. The first supply scope can take into account wares already in the supplier's warehouse, here termed stock wares 110, and wares being produced or purchased, termed as ordered wares 112. In one implementation, the request is granted if the ware is available according to the determined supply scope.

A second time period 114 can be defined as beginning at the start execution horizon 108 and ending at a release to production and purchasing horizon 116. The release to production and purchasing horizon 116 can represent the number of days from the beginning time 106 that are needed to request to order facilities to produce or purchase a ware (e.g., 15 days). If a request is received within the second time period 114, or when the delivery date of a request received earlier falls within this period, the availability determination can check against a second supply scope for the second time period 114. The second supply scope can constitute the stock wares 110, the ordered wares 112, and wares assigned to be ordered, here termed as wares 118 requested for ordering. In one implementation, the request is granted if the ware is available according to the determined supply scope.

A third time period 120 can be defined as beginning at the release to production and purchasing horizon 116 and ending at a lead time horizon 122. The lead time horizon 122 can represent the lead time period 102 from the beginning day (e.g., 30 days). If a request is received within the third time period 120, or when the delivery date of a request received earlier falls within this period, the availability determination can check against a third supply scope for the third time period 120. The third supply scope can constitute the stock wares 110, the ordered wares 112, the wares 118 requested for ordering, and items suggested to be requested to be ordered, ordered, and stocked, here termed as planned wares 124. In one implementation, the request is granted if the ware is available according to the determined supply scope.

Thus, availability determinations can be performed using any or all of the three exemplary scopes of check described above. For a ware whose delivery date is initially located in the third time period, and which over time moves through the second and first time periods, the availability checks can be performed in the order: third, then second, then first. In such an implementation, the availability determinations can be considered as progressing toward a supply scope of increasing certainty. That is, a planned ware production (third period) can be considered less definitive or certain than a requested ware production (second period). Similarly, the requested ware production can be considered less definitive or certain than the ordered ware production (first period). Thus, an availability confirmation can be repeatedly issued, each time based on increasingly reliable or certain supply information.

Requests can have delivery dates that originally fall outside the three time periods. A fourth time period 126 can be defined as beginning at the lead time horizon 122. In some implementations, the fourth time period may have an end. In other implementations, the fourth time period may not have an end, creating an infinite length of time on the time axis. If a request falls within the fourth time period 126, the request can be automatically granted, in some implementations.

The supply scopes can also include previous requests, termed sales orders 128-132. A first sales order 128 is shown within the first time period 104. For example, a customer can submit the first sales order 128 with a delivery date within the first time period 104. In one implementation, the ability to confirm the sales order 128 is determined by taking into account the stock wares 110 and the ordered wares 112, according to the first supply scope.

A second sales order 130 is shown within the second time period 114. For example, a customer can submit the second sales order 130 with a delivery date within the second time period 114. In one implementation, the ability to confirm the sales order 130 is determined by taking into account the stock wares 110, the ordered wares 112, and the wares 118 requested for ordering, according to the second supply scope.

A third sales order 132 is shown within the third time period 120. For example, a customer can submit the third sales order 132 with a delivery date corresponding to the third time period 120. In one implementation, the ability to confirm the sales order 132 is determined by taking into account the stock wares 110, the ordered wares 112, the wares 118 requested for ordering, and planned wares 124, according to the third supply scope.

In some implementations, the availability determination may indicate a lack of availability in the time period for the request's delivery date. This can be because, using the applicable scope of check, the available number of products is less than the number of products requested to be delivered. In such an instance, the availability determination can generate a confirmation date showing a date in the next time period, or later, when the system shows the product is available. The availability determination can check for a possible confirmation date in successive time periods until availability can be confirmed, for example because the confirmation date passes beyond the lead time horizon 122, where the request can be granted automatically. Thus, in such situations there may be a discrepancy between the requested delivery date (i.e., the specified date when the customer needs the ware), and the confirmation date (i.e., the first date when the requested amount of the ware can be delivered to the customer). The customer may decide to accept the confirmation date instead of the requested delivery date. If so, the requested delivery date recorded in the system may be updated.

In other implementations, an industry may have a faster turn-around time. For example, in the floral industry before a holiday, requests for arrangements may come in for deliveries the same day. The beginning time 106 can represent a specific time (e.g., 12:04 p.m.), the start execution horizon 108 can represent the time the particular arrangement takes to make (e.g., 30 minutes), and the release to a production and purchasing horizon 116 can represent the time to plan arrangements (e.g., 45 minutes).

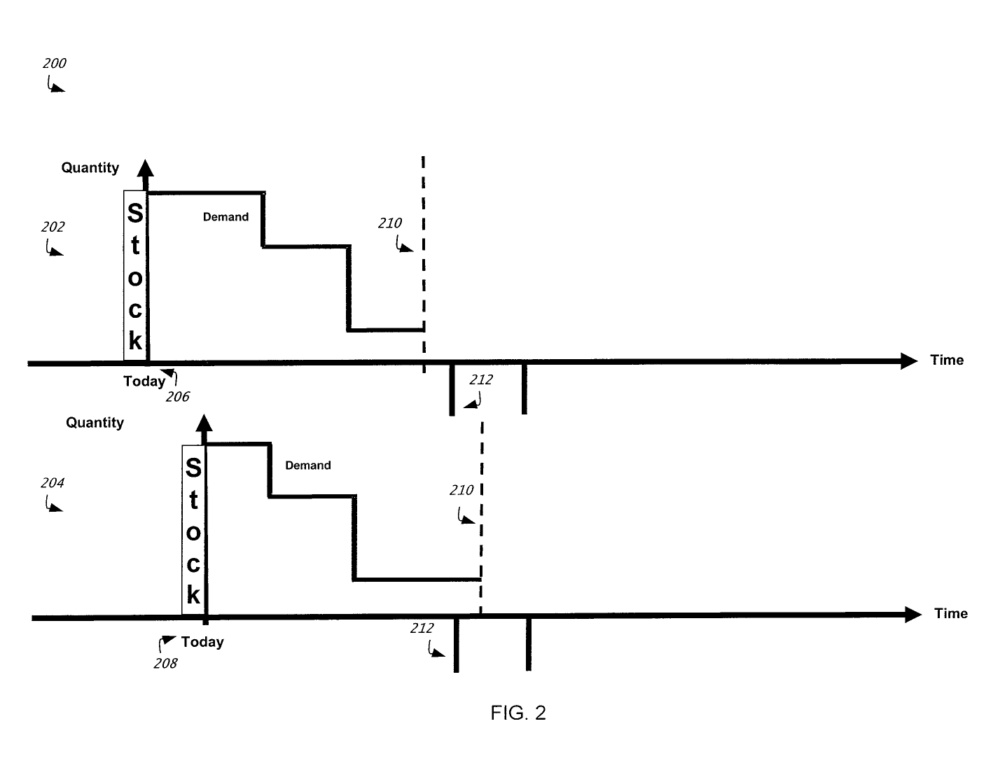

FIG. 2 shows two charts 202 and 204 conceptually illustrating how the passage of time can effect the availability determination. In general, updating the availability determination can provide better information as to the status of requests. For consistency, a request that has once been confirmed should preferably not be rejected later. That is, the better information available through the different scopes of check should be used, if possible, to verify that the already confirmed request can still be confirmed for its requested delivery date.

In FIG. 2, each of the charts 202 and 204 is associated with a particular point in time. For example, the chart 202 may represent the first day of February and the chart 204 may represent a week later. Accordingly, the first chart 202 illustrates a time that occurs prior to the time in which a second chart 204 occurs. A first beginning time 206 shows the position in time for the first chart 202. A second beginning time 208 shows the position in time for the second chart 204. A horizon 210 in the first chart 202 has a first predetermined distance from the first beginning time 206. The horizon 210 in the second chart 204 has a second predetermined distance from the second beginning time 208. The first predetermined distance and the second predetermined distance are here equal, termed as the predetermined distance. A request 212 is shown before the horizon in the first chart 202 and is shown after the horizon in the second chart 204. The change in time between the two charts (one week in this example) can be seen in that the request 212 is further to the left (closer to today's date) in the chart 204, while its delivery date is the same in both charts. Thus, this change in position represents the change in time between the first chart 202 and the second chart 204.

The following example illustrates how availability checking can be performed at the two times represented by the charts 202 and 204. First, the request 212 is outside the horizon 210. In the described example, this means that a first scope of check is used to determine availability of the ware. The request 212 is here confirmed, according to the scope of check applied in the chart 202. Then, the request 212 appears inside the horizon 210 as time passes. Next, a second scope of check can be used. Now, the request may or may not be confirmed depending on the availability according to the different scope of check.

In other implementations, multiple horizons can be used to update availability determinations as time progresses. For example, if the request 212 outside the horizon 210 can be assigned to be ordered, the request 212 appearing inside the horizon 210 can currently be in the process of being produced or purchased. The horizon 210 can be termed a start execution horizon based on a conversion before the horizon to after the horizon. In another example, if the request 212 outside the horizon can be assigned to be requested to be ordered, ordered, and stocked, the request 212 appearing inside the horizon 210 can be assigned to be ordered. The horizon 210 can be termed a release to production and purchasing horizon based on a handover before the horizon to after the horizon. Other horizons and/or definitions of time periods can be used.

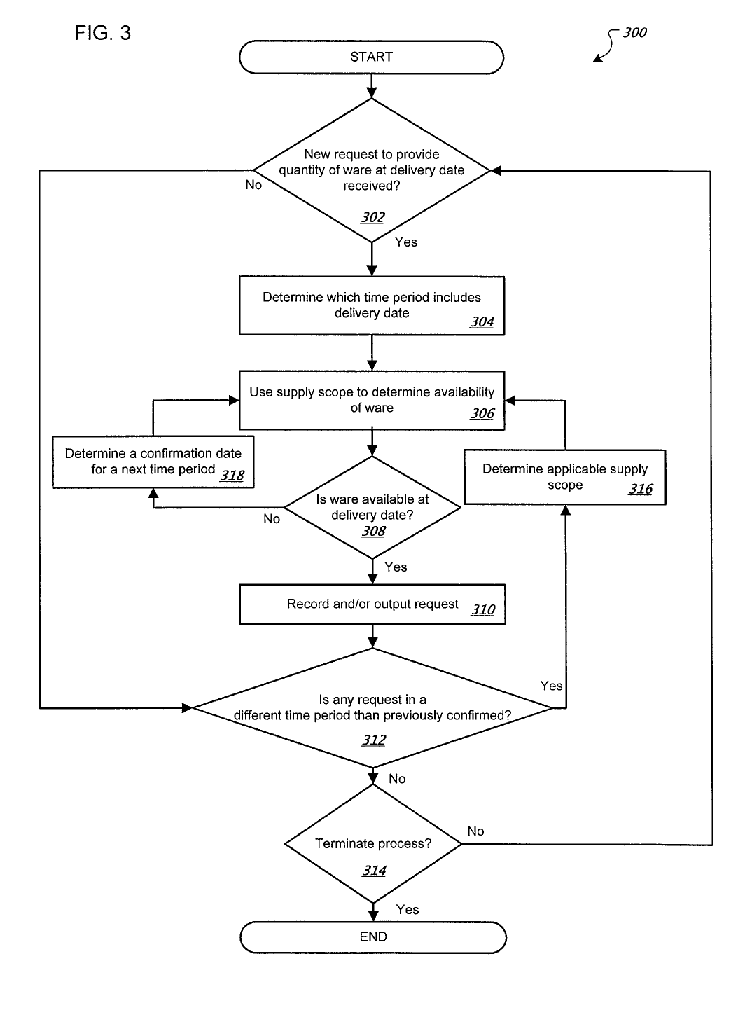

FIG. 3 is an example of a method 300 that can be performed. For example, the method 300 can be performed to generate data to display information similar, or corresponding, to the information in the chart 100. The method 300 can be performed by a processor executing instructions stored in a computer-readable storage medium.

In step 302 it is determined whether a new request to provide a quantity of a ware at a delivery date has been received. If so, then the process 300 determines which one of multiple time periods includes the delivery date at step 304. There are at least three time periods that run serially from a beginning time. Each of the multiple time periods corresponds to a step in a process to provide the ware. Each of the multiple time periods is associated with a different supply scope for determining ware availability. For example, the three time periods can represent the time to plan, request to order, order, and stock an item as shown in FIG. 1. The three time periods can also include the lead time period 102, to name another example.

The method 300 includes, in step 306, determining the availability of the ware for the request using the supply scope of the determined time period. For example, the supply scope for the first time period 104 can take into account the stock wares 110 and the ordered wares 112 as shown in FIG. 1.

If, at step 308, the ware is available at the delivery date, then the method 300 records and/or outputs the request in step 310. For example, this can include generating a confirmation date reflecting a date when the system shows the product is available. The process then determines in step 312 whether or not any request is in a different time period than the time period in which availability for that request was calculated. For example, the passage of time illustrated by the charts 202 and 204 in FIG. 2 can lead to the request 212 moving inside the horizon 210, and thus into another time period than where a previous confirmation was made. The availability of the ware for the request is determined using the supply scope of the current time period. For example, if a request moves into the second time period 114 (FIG. 1) as time passes, the availability for the request can be determined using the supply scope for that period.

If the method 300 determines in step 312 that no request is in any different time period now, then the method 300 can determine whether or not to terminate in step 314. For example, the method 300 can continue executing until a user terminates it or until the system is shut down. If the method 300 terminates, the method 300 ends. Otherwise, the method 300 returns to step 302 to determine if a new request is received to provide a quantity of a ware at a new delivery date.

If the request is now in a different time period in step 312, the method 300 can determine the applicable supply scope in step 316 based on the currently correct one of the time periods.

Once the method 300 determines the applicable supply scope, the method 300 returns to step 306. The updated determination is then made using the supply scope of the other one of the time periods. For example, if the request 212 changes positions from outside the horizon 210 to inside the horizon 210, the availability request can be updated to use the supply scope of the time period inside the horizon 210 as shown in FIG. 2. If the method 300 determines in step 308 that the ware is not available at the delivery date, then the method 300 can seek to determine a later confirmation date when the product is available. For example, the method 300 can determine whether the confirmation date can be issued for a next one of the multiple time periods further from the beginning time in step 318. For example, if the request cannot be filled in the first time period 104, the request can be (at least temporarily) moved to the second time period. Then, the supply scope for the second time period 114 can be used to determine availability of the ware in the second time period 114 as shown in FIG. 1. In some implementations, if the next time period is beyond the lead time period 102 (i.e., after the lead time horizon 122), the supply scope to be used can be defined such that the ware is always deemed to be available. The method 300 then returns to step 306.

Other steps can be included in the method 300. Some or all of the steps of the method 300 may be performed in another order.

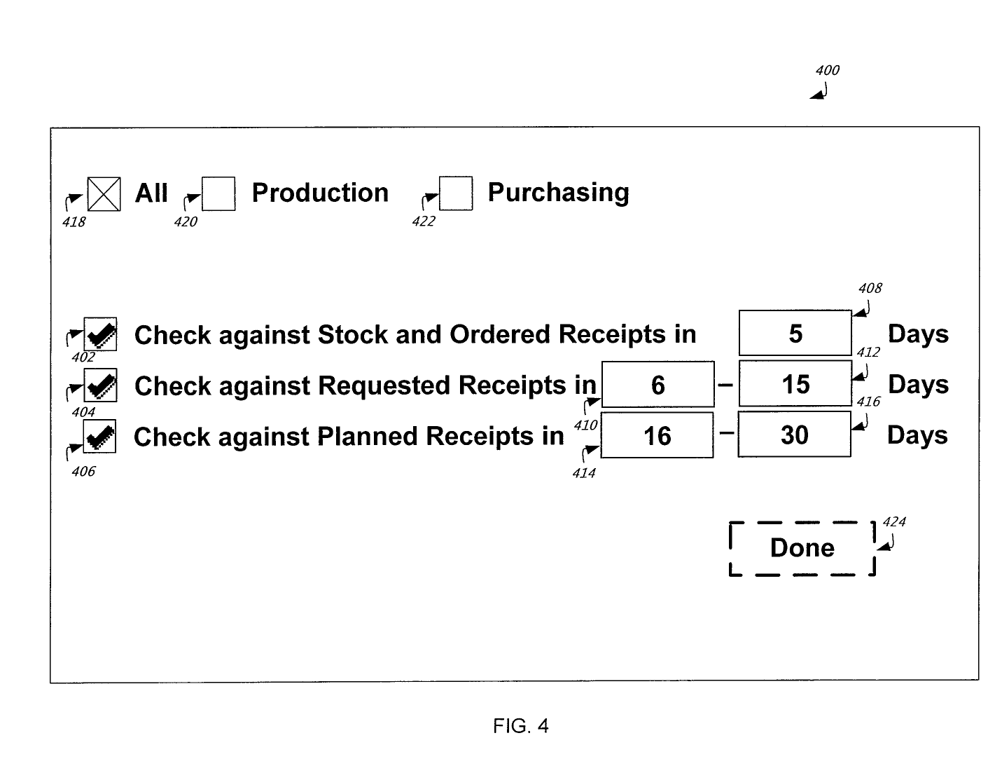

FIG. 4 is an example of a graphical user interface (GUI) 400 for defining horizons that can be used in an availability check. The GUI 400 allows a user to choose one or more time periods to be used in the availability check and how long each of the time periods will be. The GUI 400 provides the user with the choice of viewing wares from purchasing, production, or both.

In FIG. 4, three time period boxes, 402-406, have been selected. For example, a first time period box 402 can be associated with the first time period 104 in FIG. 1. A second time period box 404 can be associated with the second time period 114. A third time period box 406 can be associated with the third time period 120. In some implementations, the user may need to provide information for a horizon only when a corresponding time period box is selected. For example, the user can enter a numerical value into a first horizon box 408 only if the first time period box 402 is selected. In other implementations, if the user enters a value in the first horizon box 408, the GUI 400 can automatically select the first time period box 402.

In FIG. 4, the information provided corresponds to the number of days between a beginning time and a start execution horizon. For example, if the user enters “5” in the first horizon box 408, the first time period will extend five days forward from the current date. In some implementations, the time period can be defined in other increments of time, such as minutes, hours, weeks, months or years.

The second time period box 404 here corresponds to two horizon boxes. Second horizon boxes 410-412 provide the length of time for the second time period. For example, a “6” can automatically be entered in a start time period box 410 as a next incremented value based on the user entry in the box 408, and the user can enter a “15” in a second horizon box 412, the second time period will then extend six-fifteen days from the current date. In some implementations, the user can input the value into the box 410, and may then choose to enter same value in the first horizon box 408 and the start horizon box 410. If the availability determination provides hourly assignments to the requests, this can allow requests that are between five and six days away from the beginning time a specified time period, namely the second time period. Conversely, the GUI 400 can return an error message if the user enters the same value in the first horizon box 408 and the start horizon box 410.

The third time period box 406 here corresponds to two horizon boxes. Third horizon boxes 414-416 provide the length of time for the second time period. For example, a “16” can automatically be entered in a start time period box 414 as a next incremented value based on the user entry in the box 412, and the user can enter a “30” in a third horizon box 416, the third time period will then extend sixteen-thirty days from the current date. In some implementations, the user can input the value in the start horizon box 414.

In some implementations, the user can also identify what type of wares are to be checked in the availability check by selecting an all box 418, a production box 420, or a purchasing box 422. For example, the all box 418 can determine requests against current stock, wares to be purchased and wares to be produced. The production box 420 can be selected if the user wants to determine requests against current stock and wares to be produced. Similarly, the purchasing box 422 can be selected if the user wants to determine requests against current stock and wares to be purchased. In some implementations, the GUI 400 can display only the production box 420 and the purchasing box 422. For example, if the user wants to have both sets of data, the user can select both boxes to provide the same result as if the all box 418 had been available.

In some implementations, a done button 424 can be implemented to provide the user a way to finalize her input. In other implementations, the GUI 400 can receive information as it is input without having a done button available to the user.

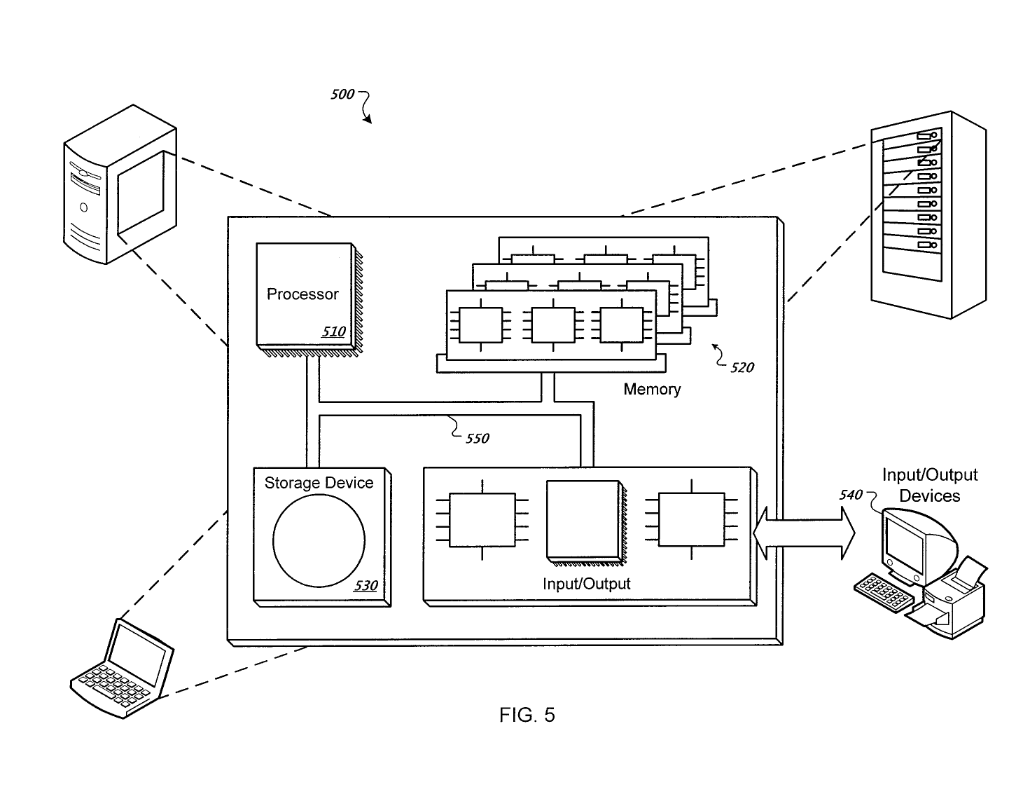

FIG. 5 is a schematic diagram of a generic computer system 500. The system 500 can be used for the operations described in association with any of the computer-implement methods described previously, according to one implementation. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

What is claimed is:

1. A computer-implemented method for making an availability determination regarding a requested ware, the method comprising:
identifying a request to provide a quantity of a ware at a delivery date;
determining, in response to the identification, which one of multiple time periods includes the delivery date, the multiple time periods being at least three and running serially from a beginning time, each of the multiple time periods corresponding to a step in a process to provide the ware and being associated with a different supply scope for determining ware availability; and
determining availability of the ware for the request using the supply scope of the determined time period.

2. The computer-implemented method of claim 1, wherein a lead time period of the multiple time periods furthest from the beginning time is defined as beginning with a lead time horizon that represents a time required for a process of providing the ware.

3. The computer-implemented method of claim 2, wherein the supply scope for the lead time period is defined such that when the delivery date falls beyond the lead time period the ware is always deemed to be available.

4. The computer-implemented method of claim 3, wherein the determination comprises that the quantity of the ware is not available at the delivery date, further comprising:
determining availability of the ware for the request using the supply scope of the next time period; and
if there is availability, generating a confirmation date within the next time period.

5. The computer-implemented method of claim 1, wherein the supply scope for a first one of the multiple time periods comprises that the ware availability is determined against stock wares and ordered wares.

6. The computer-implemented method of claim 5, wherein the first time period is defined as beginning at the beginning time and ending at a start execution horizon.

7. The computer-implemented method of claim 6, wherein the start execution horizon is defined based on a conversion from a production request to a production order in the process to provide the ware.

8. The computer-implemented method of claim 6, wherein the supply scope for a second one of the multiple time periods comprises that the ware availability is determined against stock wares, ordered wares and wares requested to be ordered.

9. The computer-implemented method of claim 8, wherein the second time period is defined as beginning at the start execution horizon and ending at a release to production and purchasing horizon.

10. The computer-implemented method of claim 9, wherein the release to production and purchasing horizon is defined based on a handover from planning in the process to provide the ware.

11. The computer-implemented method of claim 9, wherein the supply scope for a third one of the multiple time periods comprises that the ware availability is determined against stock wares, ordered wares, wares requested to be ordered and planned wares.

12. The computer-implemented method of claim 5, wherein the supply scope for the first time period comprises at least one selected from the group consisting of:
a supply scope that the ware availability is determined against stock wares and wares ordered to be produced;
a supply scope that the ware availability is determined against stock wares and wares ordered to be purchased; and
combinations thereof.

13. The computer-implemented method of claim 1, further comprising:
later updating the determination when the delivery date is in another one of the multiple time periods, the updated determination being made using the supply scope of the other one of the multiple time periods.

14. A computer program product tangibly embodied in a computer-readable storage medium and comprising instructions that when executed by a processor perform a method for making an availability determination regarding a requested ware, the method comprising:
identifying a request to provide a quantity of a ware at a delivery date;
determining, in response to the identification, which one of multiple time periods includes the delivery date, the multiple time periods being at least three and running serially from a beginning time, each of the multiple time periods corresponding to a step in a process to provide the ware and being associated with a different supply scope for determining ware availability; and
determining availability of the ware for the request using the supply scope of the determined time period.

15. A computer program product tangibly embodied in a computer-readable storage medium, the computer program product including instructions that, when executed, generate on a display device a graphical user interface for defining multiple time periods for determining availability of a requested ware, the graphical user interface comprising:
at least one input control for user entry of first and second horizons defining at least three time periods running serially from a beginning time, each of the at least three time periods corresponding to a step in a process to provide a ware and being associated with a different supply scope for determining ware availability;
wherein, when a request to provide a quantity of the ware at a delivery date is identified, it is determined which one of the at least three time periods includes the delivery date, and an availability of the ware for the request is determined using the supply scope of the determined time period.

16. The computer program product of claim 15, wherein a lead time period of the at least three time periods furthest from the beginning time is defined as beginning with a lead time horizon that represents a time required for a process of providing the ware.

17. The computer program product of claim 15, wherein the supply scope for a first one of the multiple time periods comprises that the ware availability is determined against stock wares and ordered wares.

18. The computer program product of claim 17, wherein the supply scope for the first time period comprises at least one selected from the group consisting of:
a supply scope that the ware availability is determined against stock wares and wares ordered to be produced;
a supply scope that the ware availability is determined against stock wares and wares ordered to be purchased; and
combinations thereof.

19. The computer program product of claim 15, wherein the supply scope for a second one of the multiple time periods comprises that the ware availability is determined against stock wares, ordered wares and requested wares.

20. The computer program product of claim 15, wherein the supply scope for a third one of the multiple time periods comprises that the ware availability is determined against stock wares, ordered wares, requested wares and planned wares.
